(19) United States
(12) Patent Application Publication
(10) Pub. No.: US 2013/0029060 A1
(43) Pub. Date: Jan. 31, 2013

(54) LIGHT GUIDE PLATE REPAIRING METHOD

(71) Applicants: TAI-CHERNG YU, Tu-Cheng (TW); DA-WEI LIN, Tu-Cheng (TW)

(72) Inventors: TAI-CHERNG YU, Tu-Cheng (TW); DA-WEI LIN, Tu-Cheng (TW)

(73) Assignee: HON HAI PRECISION INDUSTRY CO., LTD., Tu-Cheng (TW)

(21) Appl. No.: 13/329,226

(22) Filed: Dec. 17, 2011

(30) Foreign Application Priority Data
Jul. 27, 2011 (TW) 100126495

(51) Int. Cl. B05D 3/06; B05D 5/06

(52) U.S. Cl. 427/558

(57) ABSTRACT

A light guide plate repairing method for repairing a light guide plate is provided. The light guide plate has a scratch on at least one surface. The light guide plate repairing method includes steps as followed: laying a UV curing adhesive on the at least one surface; scraping the UV curing adhesive on the surface of the light guide plate to fill the UV curing adhesive in the scratch by a scraper; emitting a UV light for illuminating the UV curing adhesive on the surface of the light guide plate to solidify the UV curing adhesive by a UV light source; polishing the surface of the light guide plate after the UV curing adhesive has been solidified by a polishing device; and wiping and cleaning the surface of the light guide plate after the surface of the light guide plate has been polished by a wiper.

### BACKGROUND

1. Technical Field

The present disclosure relates to repairing methods and, particularly, to a light guide plate repairing method.

2. Description of Related Art

In order to prevent a light guide plate from being scratched; a protective film is usually adhered on the surface. However, the protective film can only be used to prevent the light guide plate from being scratched, if the light guide plate has already scratched, the protective film cannot repair the scratch of the light guide plate, the light guide plate could be discarded, which results in a waste of resources.

Therefore, what is needed is a light guide plate repairing method to overcome the described limitations.

### BRIEF DESCRIPTION OF THE DRAWINGS

FIG. 1 is a flowchart of a light guide plate repairing method for repairing the light guide plate in accordance with an exemplary embodiment.

FIGS. 2-8 are schematic illustrations for repairing a light guide plate implemented by the light guide plate repairing method of FIG. 1.

### DETAILED DESCRIPTION

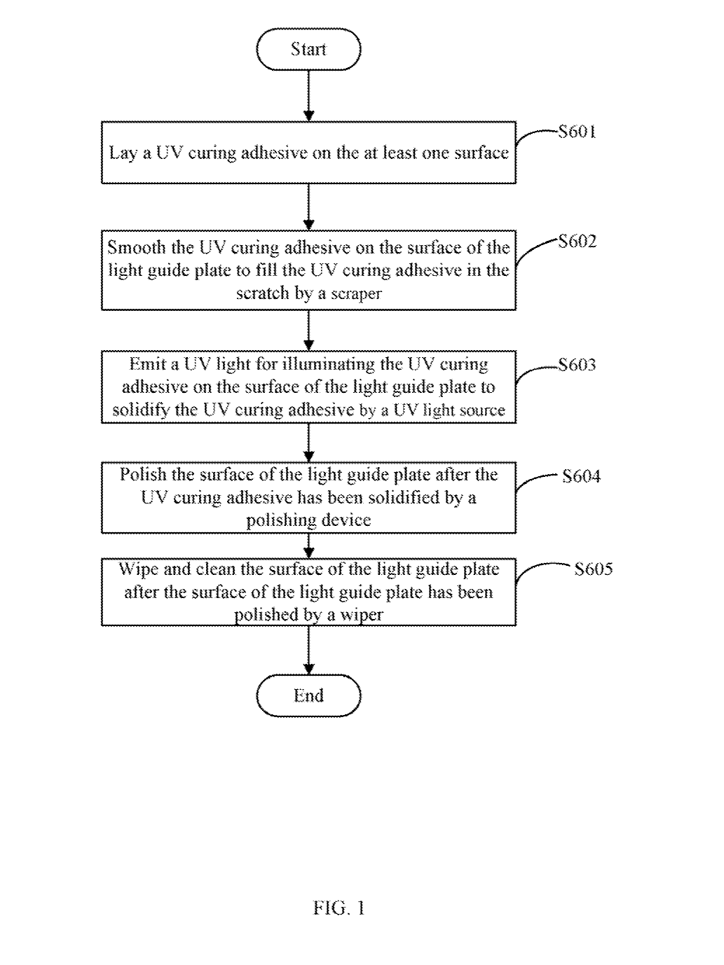

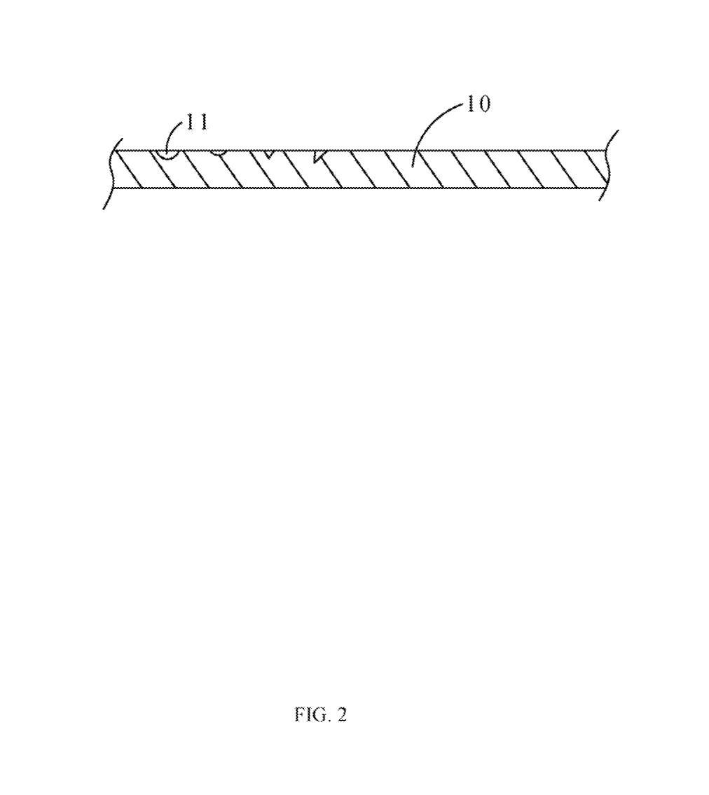

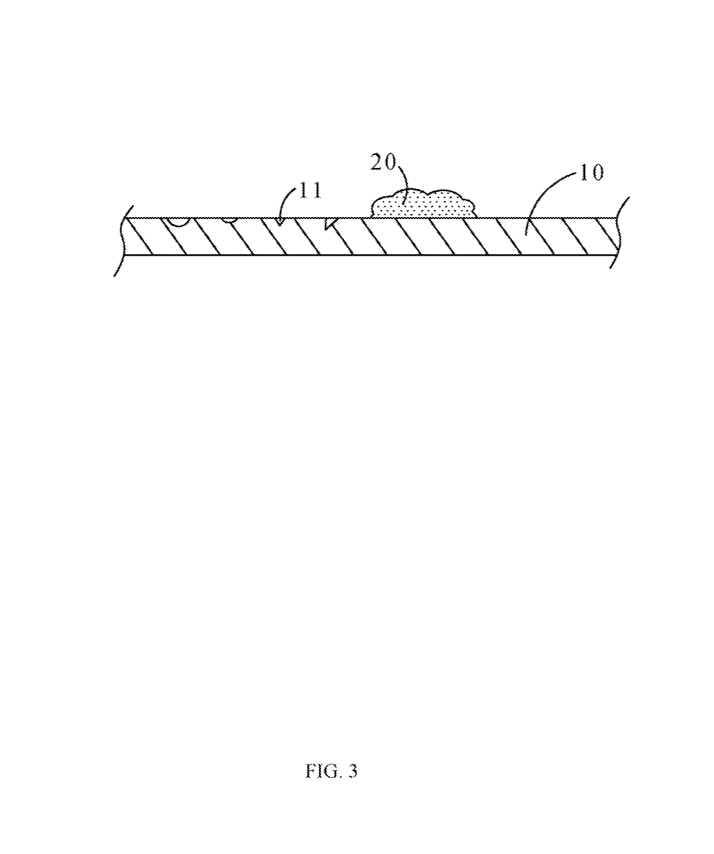

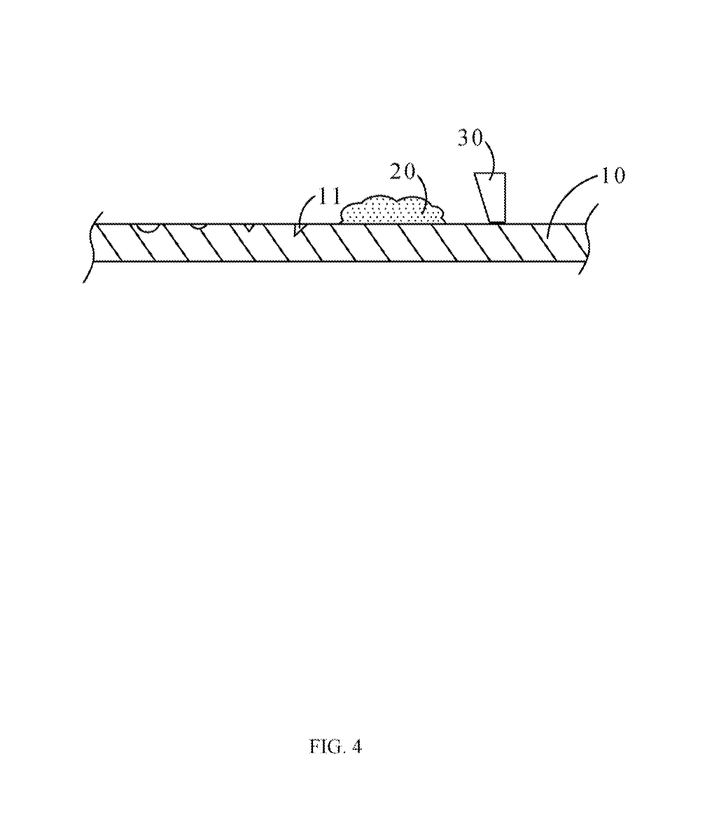

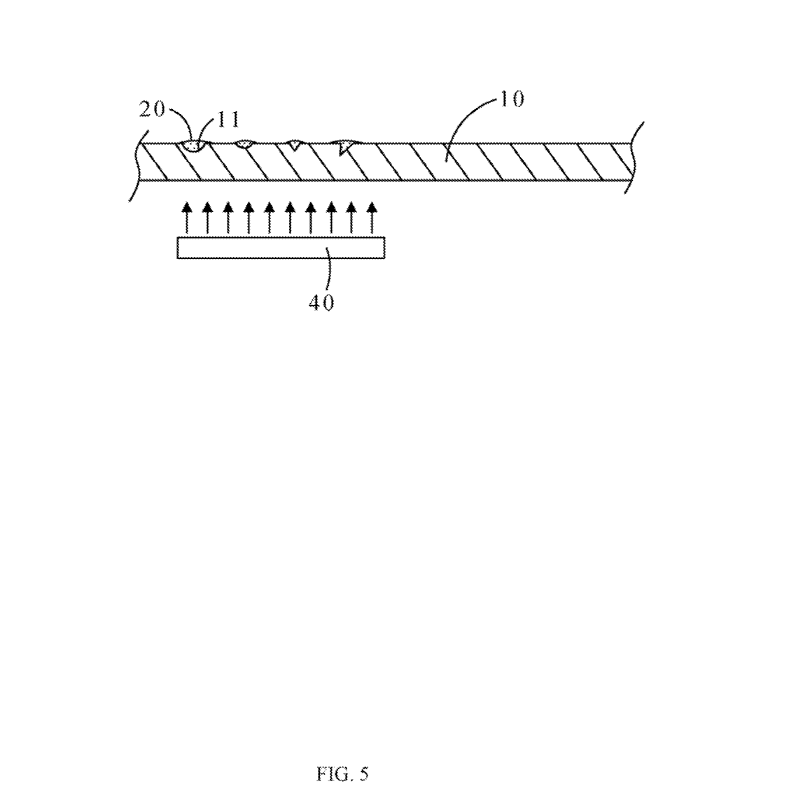

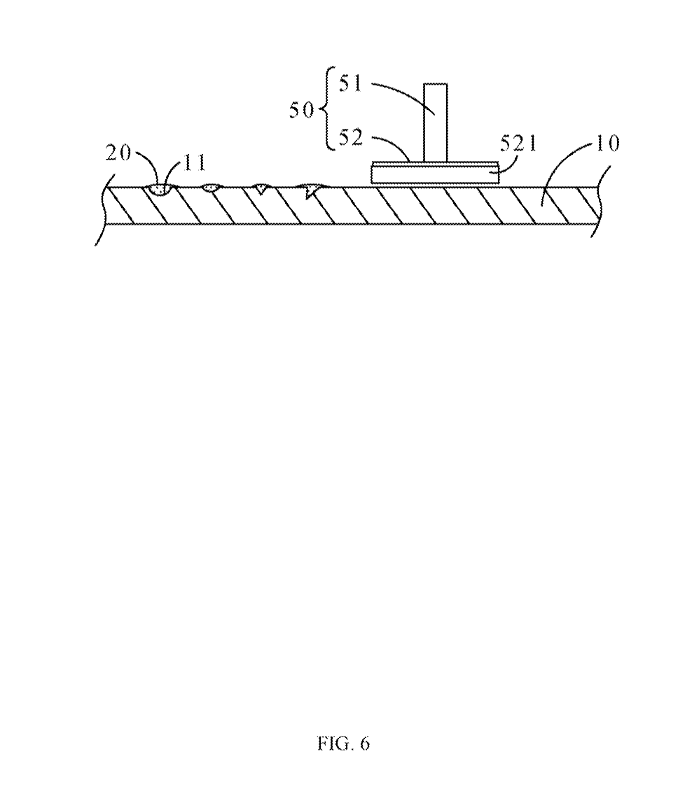

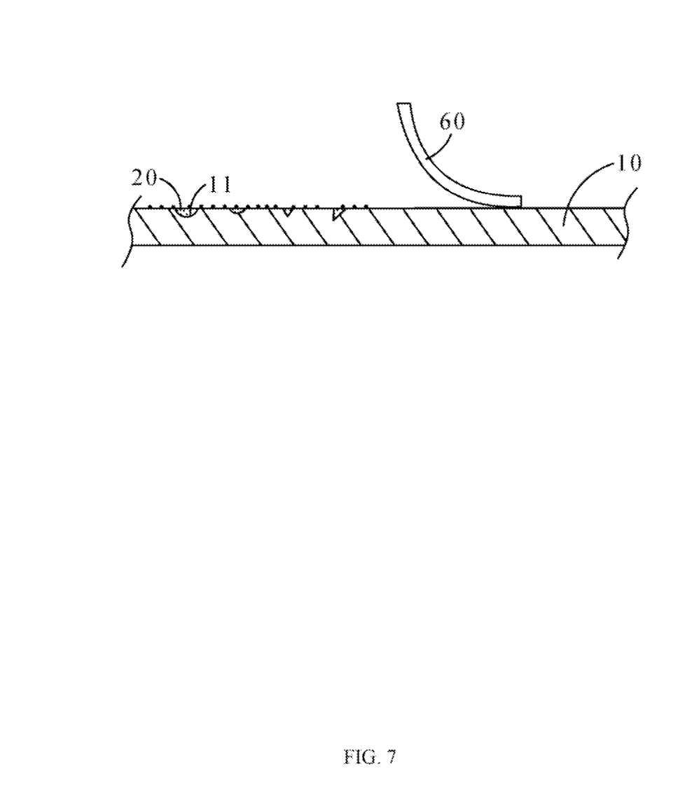

FIG. 1 is a flowchart of a light guide plate repairing method for repairing the light guide plate implemented by a UV (ultraviolet) curing adhesive 20, a scraper 30, a UV light source 40, a polishing device 50, a wiper 60, and a detergent (not labeled), in accordance with an exemplary embodiment. Referring also to FIG. 2-8, at least one surface of the light guide plate 10 has a scratch 11. In one embodiment, the light guide plate 10 is horizontally placed, and the scratch 11 forms on an upper surface. Material of the light guide plate 10 is polymethylmethacrylate (PMMA). In one embodiment, there are four scratches 11 defined in the surface of the light guide plate 10.

In step S601, the UV curing adhesive 20 is laid on the upper surface of the light guide plate 10. In one embodiment, viscosity range of the UV curing adhesive 20 is from 1000 cps to 10000 cps. Refractive index of the UV curing adhesive 20 matches that of the light guide plate 10. The UV curing adhesive 20 is a PMMA UV curing adhesive.

In step S602, the scraper 30 smoothes the UV curing adhesive 20 on the upper surface of the light guide plate 10 to fill the UV curing adhesive 20 in the scratch 11 of the light guide plate 10. The scraper 30 is made of flexible material to prevent the scraper 30 from making a new scratch on the upper surface of the light guide plate 10. In one embodiment, the scraper 30 is made of rubber. When scraping the UV curing adhesive 20, space forms between a lower edge of the scraper 30 and the upper surface of the light guide plate 10, thereby preventing the scraper 30 from touching the upper surface of the light guide plate 10.

In step S603, the UV light source 40 emits the UV light for illuminating the UV curing adhesive 20 on the upper surface of the light guide plate 10 to solidify the UV curing adhesive 20. In one embodiment, a natural temperature is 25 degrees when the UV light source 40 illuminates the UV curing adhesive 20.

In step S604, the polishing device 50 polishes the surface of the light guide plate 10 after the UV curing adhesive 20 has been solidified. The polishing device 50 includes a shaft 51 and a polishing head 52 connected to the shaft 51. The shaft 51 is used to drive the polishing head 52 to rotate and move. When polishing the surface of the light guide plate 10, the polishing device 50 moves along an orientation parallel to the surface of the light guide plate 10, the polishing head 52 is rotated by the shaft 51 to touch the upper surface of the light guide plate 10 to polish the surface of the light guide plate 10. In one embodiment, a flexible polishing material 521 is stuck on an outer surface of the polishing head 52. The flexible polishing material is wool.

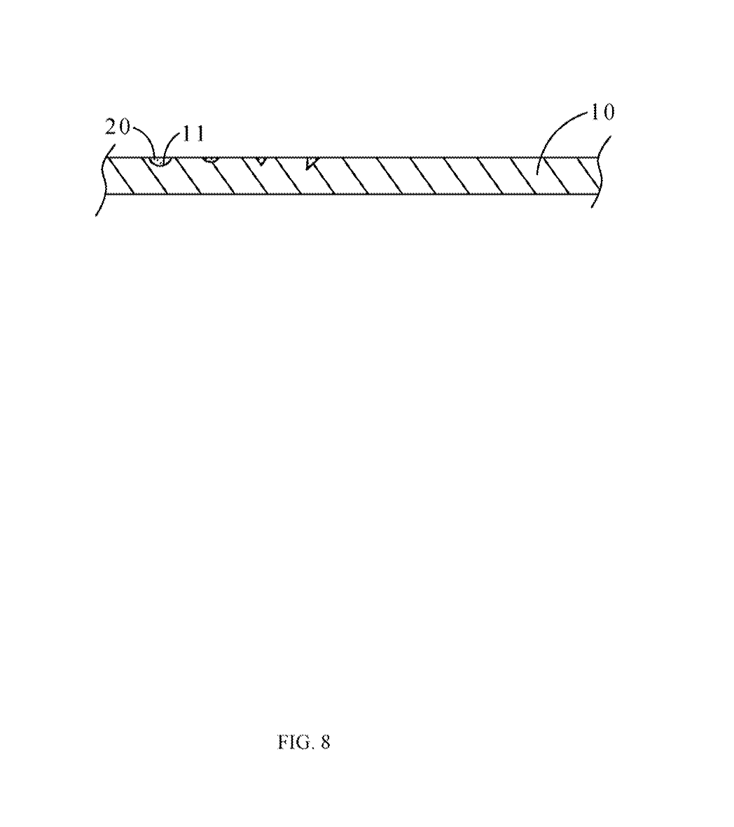

In step S605, the wiper 60 dips the detergent to wipe and clean the surface of the light guide plate 10 after the surface of the light guide plate 10 has been polished. In one embodiment, the wiper 60 is non-dust cloth. The detergent is ethanol. As shown in FIG. 8, the scratch 11 of the light guide plate 10 has been repaired.

Although the present disclosure has been specifically described on the basis of the embodiments thereof, the disclosure is not to be construed as being limited thereto. Various changes or modifications may be made to the embodiments without departing from the scope and spirit of the disclosure.

What is claimed is:

1. A light guide plate repairing method for repairing a light guide plate which has a scratch on at least one surface thereof, the method comprising:
laying a UV curing adhesive on the at least one surface;
scraping the UV curing adhesive on the surface of the light guide plate to fill the UV curing adhesive in the scratch by a scraper;
emitting a UV light for illuminating the UV curing adhesive on the surface of the light guide plate to solidify the UV curing adhesive by a UV light source;
polishing the surface of the light guide plate after the UV curing adhesive has been solidified by a polishing device; and
wiping and cleaning the surface of the light guide plate after the surface of the light guide plate has been polished by a wiper.

2. The light guide plate repairing method as described in claim 1, wherein refractive index of the UV curing adhesive matches that of the light guide plate.

3. The light guide plate repairing method as described in claim 1, wherein viscosity range of the UV curing adhesive is from 1000 cps to 10000 cps.

4. The light guide plate repairing method as described in claim 1, wherein the scraper is made of rubber.

5. The light guide plate repairing method as described in claim 1, wherein space forms between a lower edge of the scraper and the surface of the light guide plate, thereby preventing the scraper from touching the surface of the light guide plate.

6. The light guide plate repairing method as described in claim 1, wherein the polishing device comprises a shaft and a polishing head, the method for polishing the surface of the light guide plate further comprises:
driving the polishing head to rotate and move by the shaft; and
polishing the surface of the light guide plate by the polishing head.

7. The light guide plate repairing method as described in claim 1, wherein a flexible polishing material is stuck on an outer surface of the polishing head.

8. The light guide plate repairing method as described in claim 7, wherein the flexible polishing material is wool.
